(19) United States
(12) Patent Application Publication
(10) Pub. No.: US 2026/0044044 A1
(43) Pub. Date: Feb. 12, 2026

(54) Panel With Switchable Layer to Obscure Display

(71) Applicant: APPLE INC., Cupertino, CA (US)

(72) Inventors: David E. KINGMAN, Cupertino, CA (US); Paul M. CONNOLLY, Cupertino, CA (US); Peter F. MASSCHELEIN, Cupertino, CA (US)

(21) Appl. No.: 19/101,979

(22) PCT Filed: Aug. 10, 2023
(86) PCT No.: PCT/US2023/029942

§ 371 Date: Feb. 7, 2025

Related U.S. Application Data
(60) Provisional application No. 63/406,488, filed on Sep. 14, 2022.
(60) Provisional application No. 63/424,641, filed on Nov. 11, 2022.

(51) Int. Cl. G02F 1/153; B32B 3/26; B32B 17/10; B60Q 1/50; G09F 21/04

(52) U.S. Cl. CPC G02F 1/1533; B32B 3/266; B32B 17/10513; B60Q 1/5035; G09F 21/048; B32B 2605/00

(57) ABSTRACT

A panel includes a first layer that is exposed to an exterior. The panel further includes a second layer that is located inward from the first layer. The panel further includes an intermediate layer that is located between the first layer and the second layer. The panel further includes a mask layer that is located between the first layer and the second layer. The mask layer has an opening that extends therethrough. The panel further includes a conceal layer that is located between the first layer and the second layer. The conceal layer is configured to change states to obscure the opening relative to the exterior.

### CROSS-REFERENCE TO RELATED APPLICATIONS

This application is a National Stage Application of International Application No. PCT/US2023/029942 filed on Aug. 10, 2023, which claims the benefit of U.S. Provisional Application No. 63/406,488, filed Sep. 14, 2022, and also claims the benefit of U.S. Patent Application No. 63/424,641, filed Nov. 11, 2022. The contents of the foregoing applications are incorporated herein by reference in their entireties for all purposes.

### FIELD

The present disclosure relates generally to the field of panels.

### BACKGROUND

Panels can be manufactured and configured to provide visibility into or out of an object. A panel can include one or more active elements that may be operated to alter a transmissivity of the panel.

### SUMMARY

One aspect of the disclosure is a panel for a vehicle. The panel includes a first layer that is exposed to an exterior of the vehicle. The panel further includes a second layer that is located inward from the first layer. The panel further includes an intermediate layer that is located between the first layer and the second layer. The panel further includes a mask layer that is located between the first layer and the second layer. The mask layer has an opening that extends therethrough. The panel further includes a conceal layer that is located between the first layer and the second layer. The conceal layer is configured to change states to obscure the opening relative to the exterior of the vehicle.

Another aspect of the disclosure is another panel for a vehicle. The panel includes a first layer. The panel further includes a second layer that is spaced from the first layer. The panel further includes a switchable layer that is located between the first layer and the second layer. The switchable layer is configured to affect whether a display mounted adjacent to the second layer is viewable through the panel. The panel further includes a mask layer that is located between the first layer and the second layer. The mask layer defines an opening that is aligned with the display.

Another aspect of the disclosure is a display system for a vehicle. The display system includes a first panel layer. The display system further includes a second panel layer that is spaced from the first panel layer. The display system further includes a display that is mounted adjacent to the second panel layer such that the display faces an exterior of the vehicle. The display system further includes an intermediate layer that is located between the first panel layer and the second panel layer. A portion of the intermediate layer is configured to switchably obscure viewing of the display from the exterior of the vehicle.

### BRIEF DESCRIPTION OF THE DRAWINGS

FIG. 1A is a front view of an example display system for a vehicle, with a portion of a panel of the display system in a first state wherein a display is viewable through the panel.

FIG. 1B is a front view of the example display system illustrated in FIG. 1A, with the portion of the panel in a second state in which the display is obscured.

FIG. 1C is a cross-sectional view of a portion of the display system illustrated in FIGS. 1A and 1B.

### DETAILED DESCRIPTION

The disclosure herein relates to panels and display systems for use with vehicles. The panels and display systems can be incorporated into portions of the body of a vehicle. For example, the panels and display systems illustrated and described herein can be incorporated into side portions, front portions, rear portions, roof portions, and the like, of a vehicle.

The panels and display systems disclosed herein may be configured for deployment in vehicles such as automobiles, trucks, recreational vehicles, and the like, as well as aircraft and watercraft. The panels may have portions that are transparent and portions that are opaque, for example masked.

The panels may include one or more active elements, such as an active element that is configured to be switchable to obscure viewing of an outward-facing display from an exterior of the vehicle, an active element that is configured to vary a transmissivity of a portion of the panel that is configured to allow outward viewing from an interior of the vehicle, or a combination thereof.

The panels and display systems disclosed herein may be configured to allow an outward-facing display to be viewable from an exterior of the vehicle while the display is active, and to obscure the display from view when the display is inactive or powered off. Display systems in accordance with the instant disclosure may include a panel and display, such as an outward-facing display. The display may be configured to display information, for example vehicle-related information, toward the exterior of the vehicle.

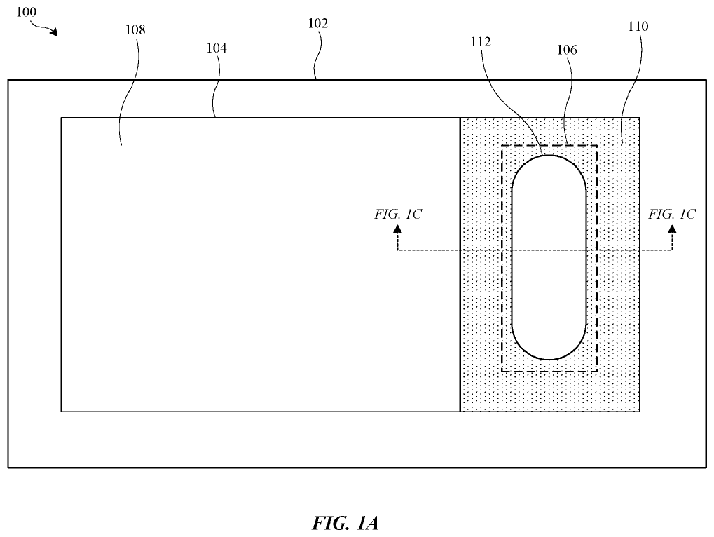

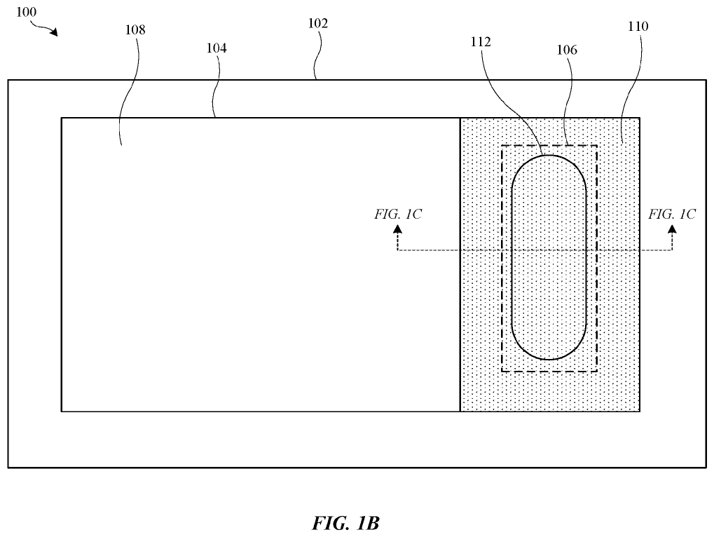

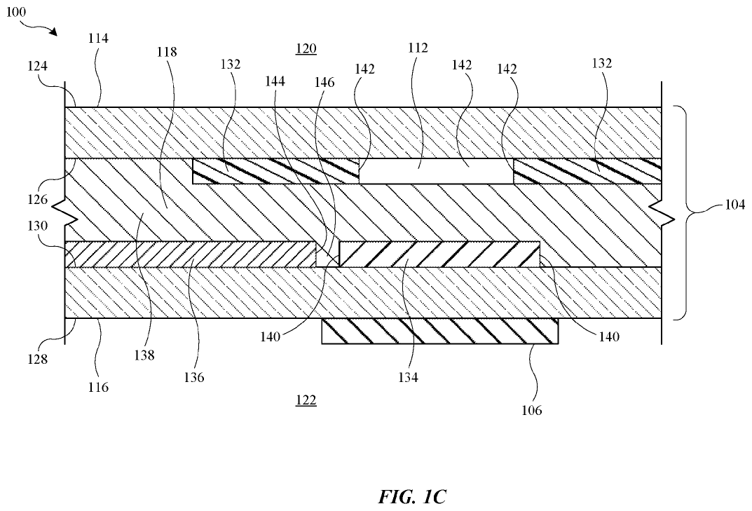

FIGS. 1A and 1B are front views of an example display system 100 in accordance with the instant disclosure. The display system 100 is incorporated into a vehicle 102. As shown, the display system 100 includes a panel 104 and a display 106. A first portion 108 of the panel 104 may be configured to be transparent, such as substantially transparent (e.g., having a transmittance value in the range of 70% to 100%, preferably of about 75%, or of about 85%, or of about 90%), to allow viewing into and out of the vehicle 102. For example, the first portion 108 of the panel 104 may be transparent to allow outward viewing of an environment external to the vehicle 102 by an occupant of the vehicle 102. Alternatively, the first portion 108 of the panel 104 may be configured to be opaque, such as substantially opaque (e.g., having a transmittance value in the range of 0% to 10%, such as of about 5%, or of about 2%, or of about 1%), to limit viewing into and out of the vehicle 102.

A second portion 110 of the panel 104 may be configured to be opaque, such that viewing inward toward an interior of the vehicle 102 is obstructed from the exterior of the vehicle 102. The second portion 110 may have a transparent, such as substantially transparent, opening 112 defined therein. The display 106 may be mounted behind the panel 104 in an outward-facing configuration, such that the display 106 is aligned with the opening 112. The opening 112 may be sized based on a viewable area of the display 106. As an example, the opening 112 may be sized so that it is within 5% greater than or less than the viewable area of the display.

When the display 106 is active, image information generated on the display 106 is viewable through the opening 112, from positions facing the display at appropriate viewing angles. In this regard, the display system 100, as shown, is configured to function as a display system for the vehicle 102. As shown, the opening 112 is defined having a rounded rectangle shape. It should be appreciated that the opening 112 can be alternatively defined with any other suitable geometry for viewing the display 106. Additionally, the display system 100 is not limited to a single opening, such as the opening 112, and can alternatively be configured with two or more openings having the same or different sizes, geometries, and the like.

The display system 100 may be incorporated into a side portion, a front portion, a rear portion, a roof portion, or a combination thereof, of the vehicle 102, or into any other suitable portion of the vehicle 102. As shown, the display system 100 is implemented in a side portion of the vehicle 102, such that the first portion 108 of the panel 104 comprises a side window of the vehicle 102, and the second portion 110 of the panel 104 is located proximate to an underlying portion of the vehicle 102, such as a structural portion of the vehicle 102 to which the display 106 is mounted. The structural portion of the vehicle 102 to which the display 106 is mounted may be, for example, an A pillar, B pillar, C pillar, D pillar, or the like. In accordance with the illustrated configuration, the display system 100 operates as an exterior display system. More specifically, the panel 104 and the display 106 are mounted to the vehicle 102 such that the display 106 is viewable from an exterior of the vehicle 102.

The display system 100 is not limited to being configured as an exterior display system. For example, in an example of an alternative configuration, the display system 100 may be implemented in a roof portion of the vehicle 102, such that the first portion 108 of the panel 104 comprises a roof window (e.g., a moonroof) of the vehicle 102, and the second portion 110 of the panel 104 is located proximate to an underlying portion of the vehicle 102, such as a structural portion of the vehicle 102 to which the display 106 is mounted. The structural portion of the vehicle 102 to which the display 106 is mounted may be, for example, a roof structural support, a roof panel, or the like. In accordance with this alternative configuration, the display system 100 operates as an interior display system. More specifically, the panel 104 and the display 106 are mounted to the vehicle 102 such that the display 106 is viewable through the opening 112 from an interior of the vehicle 102, for example by one or more occupants of the vehicle 102.

FIG. 1C is a cross-sectional view of a portion of the display system 100, with the display system 100 configured to operate as an exterior display system of the vehicle 102. For the sake of clarity, the illustration is limited to components of the display system 100 (omitting portions of the vehicle 102). The panel 104 may include a number of layers. For example, the panel 104 may be provided as a laminated panel having a number of layers. As shown, the panel 104 includes a first layer 114, a second layer 116 that is spaced from the first layer 114, and an intermediate layer 118 that is located between the first layer 114 and the second layer 116. The first layer 114 may alternatively be referred to as a first panel layer of the panel 104 and the second layer 116 may alternatively be referred to as a second panel layer of the panel 104.

As shown, the first layer 114 is located adjacent to, and is exposed to, an exterior 120 of the vehicle 102, and the second layer 116 is located inward from the first layer 114, nearer to an interior 122 of the vehicle 102. In accordance with the illustrated implementation, the display 106 is mounted adjacent to the second layer 116, such that the display 106 faces the exterior 120 of the vehicle 102.

The first layer 114 of the panel 104 may be manufactured of a transparent material that allows light to pass through the first layer 114, such as glass, a polymer, or a plastic. To illustrate, the first layer 114 may be provided as a ply of soda lime glass, mineral glass, or the like. As shown, the first layer 114 has an outer surface 124 that faces, and is exposed to, the exterior 120 of the vehicle 102 and an opposed inner surface 126 that is spaced from the outer surface 124 and contacts the intermediate layer 118.

The second layer 116 of the panel 104 may be manufactured of a transparent material that allows light to pass through the second layer 116, such as glass, a polymer, or a plastic. To illustrate, the second layer 116 may be provided as a ply of soda lime glass, mineral glass, or the like. As shown, the second layer 116 has an outer surface 128 that faces, and at least a portion of which is exposed to, the interior 122 of the vehicle 102 and an opposed inner surface 130 that is spaced from the outer surface 128 and contacts the intermediate layer 118.

As shown, the intermediate layer 118 may include a mask layer 132, a conceal layer 134, a shade layer 136, and an adhesive layer 138, each located between the first layer 114 and the second layer 116 of the panel 104. The mask layer 132 may be configured to allow viewing of the display 106, and may additionally be configured to conceal one or more underlying portions of the vehicle 102, for example portions of the vehicle 102 to which the display 106 is mounted.

The mask layer 132 may be opaque, to allow little or no light to pass through the mask layer 132. Preferably, and in accordance with the illustrated implementation, the mask layer 132 defines the opening 112. For example, a portion of material may be removed from the mask layer 132 such that the opening 112 extends therethrough and is aligned with the display 106. In this regard, the mask layer 132 defines the opening 112 through which the display 106 is viewable.

The mask layer 132 may comprise an opaque film or coating that is applied to a surface of one of the layers of the panel 104. For example, as shown the mask layer 132 is applied to the inner surface 126 of the first layer 114, such that the mask layer 132 is located within the intermediate layer 118. The mask layer 132 may be provided in a solid color or pattern that matches, or contrasts with, a decorative finish applied to surfaces, such as body panels, of the vehicle 102. Referring to FIGS. 1A and 1B, the second portion 110 of the panel 104 may comprise the mask layer 132. Stated differently, the mask layer 132 may be implemented in the second portion 110 of the panel 104.

Referring again to FIG. 1C, the conceal layer 134 may be configured to enable concealment of the display 106. Preferably, and in accordance with the illustrated implementation, the conceal layer 134 may be configured to change states to obscure the opening 112 relative to the exterior 120 of the vehicle 102, thereby concealing the display 106 relative to the exterior 120 of the vehicle 102. Stated differently, the conceal layer 134 may be configured to affect whether the display 106 is viewable through the panel 104.

As shown, the conceal layer 134 is sized to be larger than the opening 112, such that perimeter edges 140 of the conceal layer 134 extend beyond the perimeter edges 142 of the opening 112 within the assembled panel 104. In this regard, the panel 104 may be configured such that the conceal layer 134 overlaps the mask layer 132 around a perimeter of the opening 112. This configuration may conceal the perimeter edges 140 of the conceal layer 134 from being seen through the opening 112 from the exterior of the vehicle 102. The distance through which the perimeter edges 140 extend beyond the perimeter edges 142 may be determined, for example, based on effective viewing angles of the display 106.

The conceal layer 134 may be provided as an active layer that is switchable between two or more transmissivities. In this regard, the conceal layer 134 may be alternatively referred to as a switchable layer. The conceal layer 134 may be configured to switch between a first state in which the display 106 is viewable through the opening 112 in the mask layer 132, as shown in FIG. 1A, and a second state in which the display 106 is obscured relative to the opening 112, as shown in FIG. 1B.

Preferably, the conceal layer 134 may be configured to be switchable between a first state in which the conceal layer 134 is substantially transparent and a second state in which the conceal layer 134 exhibits a transmissivity that approximates a transmissivity of the mask layer 132. For example, the conceal layer 134 may be configured to have a transmittance value while in the second state that differs from that of the mask layer 132 by less than 10%, preferably by less than 5%. To illustrate, the conceal layer 134 may comprise an electrochromic film that is that is switchable between a first state in which the film exhibits a first transmissivity (e.g., a transmittance value of greater than 70%) and a second state in which the film exhibits a second transmissivity that is lower than the first transmissivity (e.g., a transmittance value in the range of 0% to 35%, preferably of about 25%). Alternatively, the conceal layer 134 may be provided using another switchable state material or active tint technology, such as guest-host liquid crystal (GHLC) cells, suspended particle device (SPD) material, or the like.

The conceal layer 134 may be configured such that the first state is active when the display 106 is actively displaying image information, thereby allowing viewing of the display 106 through the first layer from the exterior 120 of the vehicle 102, and such that the second state is active when the display 106 is inactive, for example when no image information is being displayed or the display 106 is powered off, thereby concealing the display 106 relative to the exterior 120 of the vehicle 102.

In operation, the conceal layer 134 may be configured to switch from the second state to the first state when image information is displayed by the display 106, and to switch from the first state to the second state when image information is no longer displayed on the display 106. In this regard, the conceal layer 134 comprises a portion of the intermediate layer 118 that is configured to switchably obscure viewing of the display 106 from the exterior 120 of the vehicle 102. Stated differently, the conceal layer 134 may comprise a portion of the intermediate layer 118 that is configured to be switchable between a first state in which the portion exhibits a first transmissivity and a second state in which the portion exhibits a second transmissivity that is lower than the first transmissivity.

Controlling the state switching of the conceal layer 134 may be performed, for example, by vehicle software that is executed by a vehicle controller of the vehicle 102. The vehicle controller may include hardware, software, or a combination thereof, and may be configured to monitor and/or control one or more portions of operation of the vehicle 102. In accordance with the illustrated implementation, the vehicle controller may be configured to synchronize changing of state of the conceal layer 134 with activation of the display 106 to display of image information. The vehicle controller may be configured to provide this functionality while the vehicle 102 is static, while the vehicle 102 is in motion under autonomous control, while the vehicle 102 is in motion under semi-autonomous control, or any combination thereof.

As shown, the conceal layer 134 is located between the mask layer 132 and the display 106. The conceal layer 134 may be applied to a surface of one of the layers of the panel 104. For example, as shown the conceal layer 134 is applied to the inner surface 130 of the second layer 116, such that conceal layer 134 is located within the intermediate layer 118, and such that the mask layer 132 and the conceal layer 134 are spaced from one another within the intermediate layer 118. Referring to FIGS. 1A and 1B, the second portion 110 of the panel 104 may further comprise the conceal layer 134. Stated differently, the conceal layer 134 may be implemented in the second portion 110 of the panel 104.

Referring again to FIG. 1C, the shade layer 136 may be configured to regulate the amount of light that passes through the panel 104, for example from the exterior 120 to the interior 122 of the vehicle 102. The shade layer 136 may be provided as an active layer that is switchable between two or more transmissivities. In this regard, the shade layer 136 may be alternatively referred to as a switchable layer.

Preferably, the shade layer 136 may be configured to be switchable between a first state in which the shade layer 136 is substantially transparent and a second state in which the shade layer 136 is darkened, to limit the amount of light that passes through the panel 104. To illustrate, the shade layer 136 may comprise an electrochromic film that is that is switchable between a first state in which the film exhibits a first transmissivity (e.g., a transmittance value of greater than 50%, or greater than 70%, preferably of greater than 90%) and a second state in which the film exhibits a second transmissivity that is lower than the first transmissivity (e.g., a transmissivity value of less than 50%, or in the range of 0% to 35%, preferably of about 25%, or of about 15%, or of about 12%).

In operation, the shade layer 136 may be configured to switch between the substantially transparent first state and the darkened second state based on an amount of light that is present in an ambient environment of the vehicle 102. Controlling the state switching of the shade layer 136 may be performed, for example, by the vehicle controller. For example, the vehicle controller may be configured to control the shade layer 136 to change states, for example based on data or information sensed by one or more light and/or visibility sensors of the vehicle 102 that are configured to communicate with the vehicle controller, based on pre-determined settings, based on information that is provided in real time (e.g., via one or more user inputs), based on learned or user preferences, or any combination thereof. Referring to FIGS. 1A and 1B, the first portion 108 of the panel 104 may comprise the shade layer 136. Stated differently, the shade layer 136 may be implemented in the first portion 108 of the panel 104.

Referring again to FIG. 1C, as shown, the shade layer 136 is located alongside the conceal layer 134. The shade layer 136 may be applied to a surface of one of the layers of the panel 104. For example, as shown the shade layer 136 is applied to the inner surface 130 of the second layer 116, such that shade layer 136 is located within the intermediate layer 118. In accordance with the illustrated implementation, the shade layer 136 has a lateral edge 144 that is spaced by a gap 146 from the perimeter edge 140 of the conceal layer 134 that is adjacent to the shade layer 136. The mask layer 132 extends beyond the lateral edge 144 of the shade layer 136, such that the mask layer 132 overlaps the gap 146 and a portion of the shade layer 136. Additionally, in accordance with the illustrated configuration, in which the display system 100 operates as an exterior display system, the mask layer 132 is located closer to the exterior 120 of the vehicle 102 than are the conceal layer 134 and the shade layer 136.

The adhesive layer 138 may comprise one or more layers of material that surround the mask layer 132, the conceal layer 134, and the shade layer 136 within the intermediate layer 118. The adhesive layer 138 may comprise one or more optically clear layers. For example, the adhesive layer 138 may comprise one or more layers of optically clear adhesive (OCA) film, a transparent polymer such as polyvinyl butyral (PVB), a transparent epoxy, another suitable adhesive, or any combination thereof. As shown, the adhesive layer 138 separates the mask layer 132 from the conceal layer 134 and the shade layer 136.

It should be appreciated that the panel 104 is not limited to the illustrated geometries, spacing, and locations of the mask layer 132, the conceal layer 134, and the shade layer 136 within the intermediate layer 118. For example, the panel 104 may be alternatively fabricated such that the adhesive layer 138 spaces the mask layer 132 from the inner surface 126 of the first layer 114, spaces the conceal layer 134 from the inner surface 130 of the second layer 116, spaces the shade layer 136 from the inner surface 130 of the second layer 116, or any combination thereof. Additionally, the panel 104 may be alternatively fabricated such that the thickness of the adhesive layer 138 between the mask layer 132, the conceal layer 134, and the shade layer 136 is reduced or eliminated, for example such that the conceal layer 134 and the shade layer 136 abut the mask layer 132 within the intermediate layer 118. Furthermore, the panel 104 may be alternatively fabricated with the shade layer 136 omitted. Moreover, the display system 100 may be alternatively implemented with a first polarizer in place of the conceal layer 134 and with a second polarizer that is integrated into the display 106. In such an alternative implementation, the first polarizer and the second polarizer may be aligned with one another such that the display 106 is viewable through the opening 112 when active, and obscured relative to the opening 112 when inactive or powered off.

It should further be appreciated that in a configuration in which the display system 100 operates as an interior display system, as described elsewhere herein, that the orientation of the display system may be inverted, such that the second layer 116 is adjacent to, and is partially exposed to, the exterior 120 of the vehicle 102, and the first layer 114 is located inward from the second layer 116, nearer to the interior 122 of the vehicle 102.

It should further still be appreciated that the display system 100 may be alternatively configured such that the display 106 is integrated with the panel 104. To illustrate, the panel 104 may be alternatively constructed with the display 106 embedded within the panel 104 and located between the conceal layer 134 and the second layer 116.

As described above, one aspect of the present technology is the gathering and use of data available from various sources for use during operation of a vehicle that includes the panel 104 or the display system 100. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores user-preference-related information that allows operation of a vehicle according to user preferences. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for operating a vehicle, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user preference information may be determined each time the vehicle is used, such as by prompting a user for needed information, and without subsequently storing the information or associating with the particular user.

1. A panel for a vehicle, the panel comprising:
a first layer that is exposed to an exterior of the vehicle;
a second layer that is located inward from the first layer;
an intermediate layer that is located between the first layer and the second layer;
a mask layer that is located between the first layer and the second layer, the mask layer having an opening that extends therethrough; and
a conceal layer that is located between the first layer and the second layer, the conceal layer configured to change states to obscure the opening relative to the exterior of the vehicle.

2. The panel of claim 1, wherein the conceal layer is configured to be switchable between a first state in which the conceal layer is substantially transparent and a second state in which the conceal layer exhibits a transmissivity that approximates that of the mask layer.

3. The panel of claim 2, wherein the conceal layer comprises an electrochromic film.

4. The panel of claim 1, wherein the intermediate layer comprises the mask layer and the conceal layer, and the mask layer and the conceal layer are spaced from one another within the intermediate layer.

5. (canceled)

6. The panel of claim 1, further comprising:
a shade layer that is located between the first layer and the second layer, the shade layer located in a first portion of the panel and the conceal layer located in a second portion of the panel.

7. The panel of claim 6, wherein the shade layer is configured to be switchable between a first state in which the shade layer is substantially transparent and a second state in which the shade layer is darkened.

8. The panel of claim 7, wherein the shade layer comprises an electrochromic film.

9. The panel of claim 6, wherein the mask layer overlaps a portion of the shade layer.

10. The panel of claim 6, further comprising:
an adhesive layer that separates the mask layer from the conceal layer and the shade layer, wherein the adhesive layer comprises an optically clear layer.

11. (canceled)

12. The panel of claim 10, wherein the mask layer is located closer to the exterior of the vehicle than are the conceal layer and the shade layer.

13. The panel of claim 1, wherein the conceal layer overlaps the mask layer around a perimeter of the opening.

14. A panel for a vehicle, the panel comprising:
a first layer;
a second layer that is spaced from the first layer;
a switchable layer that is located between the first layer and the second layer, the switchable layer configured to affect whether a display mounted adjacent to the second layer is viewable through the panel; and
a mask layer that is located between the first layer and the second layer, the mask layer defining an opening that is aligned with the display.

15. The panel of claim 14, wherein the switchable layer is configured to switch between a first state in which the display is viewable through the opening and a second state in which the display is obscured relative to the opening.

16. The panel of claim 14, wherein the mask layer is configured to conceal an underlying portion of the vehicle to which the display is mounted.

17. The panel of claim 14, wherein the switchable layer overlaps a perimeter of the opening.

18. The panel of claim 14, wherein the switchable layer is a first switchable layer, the panel further comprising:
a second switchable layer that is located between the first layer and the second layer, the second switchable layer configured to switch between a transparent state and a darkened state.

19. A display system for a vehicle, the display system comprising:
a first panel layer;
a second panel layer that is spaced from the first panel layer;
a display that is mounted adjacent to the second panel layer such that the display faces an exterior of the vehicle; and
an intermediate layer that is located between the first panel layer and the second panel layer, a portion of the intermediate layer configured to switchably obscure viewing of the display from the exterior of the vehicle.

20. The display system of claim 19, wherein the portion of the intermediate layer comprises an electrochromic film that is configured to be switchable between a first state in which the portion exhibits a first transmissivity and a second state in which the portion exhibits a second transmissivity that is lower than the first transmissivity.

21. The display system of claim 20, further comprising:
a mask layer that is located between the first panel layer and the second panel layer, the mask layer having an opening that extends therethrough, the opening sized based on a viewable area of the display, wherein the mask layer is configured to conceal an underlying portion of the vehicle to which the display is mounted.

22. The display system of claim 21, wherein the second transmissivity approximates that of the mask layer.

23. (canceled)
